(19) United States
(12) Patent Application Publication
(10) Pub. No.: US 2025/0356055 A1
(43) Pub. Date: Nov. 20, 2025

(54) DYNAMIC AND AUTOMATIC CERTIFICATION IN DATA ANALYTICS

(71) Applicant: Wiiisdom France, Lille (FR)

(72) Inventors: Patrick Perrier, Lille (FR); Sebastien Goiffon, Lille (FR)

(21) Appl. No.: 18/668,020

(22) Filed: May 17, 2024

(51) Int. Cl. G06F 21/64; G06F 21/62

(52) U.S. Cl. CPC G06F 21/64; G06F 21/6218

(57) ABSTRACT

The disclosure notably relates to a computer-method for data analytics. The method comprises, dynamically and automatically, obtaining one or more datasets, and a visual report generated based on the one or more datasets. The method also comprises applying a plurality of tests each to a subject element among the one or more datasets and/or the visual report. The method also comprises computing a level of certification for the visual report based on a number of tests providing a positive result.

### TECHNICAL FIELD

The disclosure relates to the field of computer programs and systems, and more specifically to a method, storage medium and system for data analytics.

### BACKGROUND

A number of systems and programs are offered on the market for performing data analytics in various fields, such as in Business Intelligence (BI) and/or analytics solutions, serving different use cases such as the Financial Services Industry (FSI), pharma, retail, among others. Such tools include for example Microsoft Power BI or Tableau Software (registered trademarks).

With such data analytics tools, users are presented with significant quantities of data and are unsure whether these data can be trusted and relied upon for making decisions. In addition, current data analytics systems suffer from issues such as the duplication of data or inconsistent metrics, which lead to an erosion in the trust by decision makers in the data presented to them.

Within this context, there is a need for an improved solution for data analytics.

### SUMMARY

It is therefore provided a computer-method for data analytics. The method comprises, dynamically and automatically, obtaining one or more datasets, and a visual report generated based on the one or more datasets. The method also comprises applying a plurality of tests each to a subject element among the one or more datasets and/or the visual report. The method also comprises computing a level of certification for the visual report based on a number of tests providing a positive result.

In examples, the plurality of tests comprises one or more of a data quality test, a metadata test, a functional or user-interaction test, a security test, an accessibility or design test, a regression test, and a performance test.

In examples, the plurality of tests comprises one or more tests each applied to a respective subject element among the one or more datasets and/or the visual report, and each to one or more results of applying a filtering to the respective subject element.

In examples, the method further comprises:
during user-interaction with a computer system:
   accessing, by a user, the visual report:
   displaying, by the computer system, a graphical representation of the level of certification of the visual report; and
   displaying, by the computer system, the visual report.

In examples, the graphical representation of the level of certification of the visual report is displayed simultaneously to and/or before the displaying of the visual report.

In examples, the graphical representation of the level of certification of the visual report is one of:
a badge,
an icon,
a stamp,
a sticker,
a watermark,
a text box message;
a notification stemming from a custom extension such as an API,
a notification stemming from a native certification flagging feature,
a notification stemming from a process such as email, an instant messaging application or a support ticket system, and
a notification stemming from a Browser extension.

In examples, the method further comprises securing access to the visual report to authorized users and validating the integrity of data for the authorized users, the securing of access comprising restricting access to data based on actors, security roles and/or settings.

In examples, the method further comprises storing a record and/or a result of each application of a respective test.

In examples, the method further comprises:
applying a performance test to at least one of a displaying, loading and/or interaction of the visual report:
computing a performance score based on a result of the performance test; and
updating the level of certification of the visual report based on the result of the performance test.

In examples, the method further comprises obtaining a certification date associated with the level of certification computed for the visual report.

It is further provided a non-transitory storage medium having recorded thereon a computer program comprising instructions which, when executed on a computer, cause the computer to perform a method for data analytics as described above.

It is further provided a system comprising a processor coupled to a non-volatile memory, the non-volatile memory having recorded thereon a computer program comprising instructions which, when executed on a computer, cause the computer to perform a method for data analytics as described above.

### BRIEF DESCRIPTION OF THE DRAWINGS

Non-limiting examples will now be described in reference to the accompanying drawings, where:

FIG. 1 shows a flowchart of the method;

FIG. 2 shows an example of the system; and

FIGS. 3 to 12 illustrate examples of the method.

### DETAILED DESCRIPTION

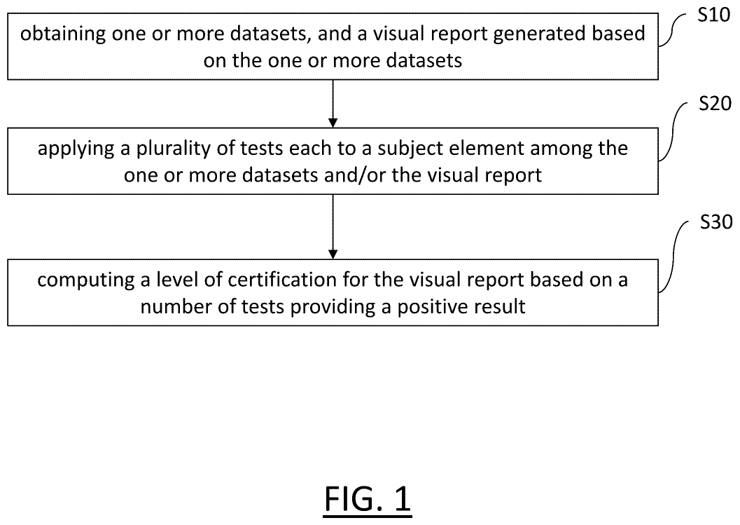

FIG. 1 shows a computer-implemented method for data analytics. The method comprises, dynamically and automatically, obtaining S10 one or more datasets, and a visual report generated based on the one or more datasets. The method also comprises, also dynamically and automatically, applying S20 a plurality of tests each to a subject element among the one or more datasets and/or the visual report. The method also comprises, also dynamically and automatically, computing S30 a level of certification for the visual report based on a number of tests providing a positive result.

Such a method forms an improved solution for data analytics. Indeed, by computing at S30 a level of certification for a visual report, the method produces information that allows to know whether or not and/or an extent to which the visual is certified, and/or reliable, and/or endorsed and/or valid and/or trustworthy. Thanks to a plurality of tests being applied at S20, the level of certification can be computed in a precise manner, and coping with many different situations. Thanks to the method being executed dynamically and automatically, minimal user intervention is required, and the level of certification can adapt to evolution of time and/or underlying data, which are potentially modified. The method thus allows users to base their decision-making on a visual report (i.e, a graphical representation of information related to the one or more datasets, e.g., and comprising one or more dashboards, one or more insights, one or more AI powered insights, and/or one or more visual metrics) in a more reliable manner, and/or to perform corrective actions if needed.

The method may in examples further comprise obtaining a certification date, for example associated with the level of certification computed for the visual report. The level of certification may be associated with a certification date. The certification date may be a timestamp associated with the computing of the level of certification, for example a time when the computing is completed. The method may comprise detecting such completion. The certification date may be of any format, for example a year, a dated month, a dated day (or date), or a combination of a date and time (at any granularity, for example hour, minute or second).

Visual reports may be handled as a tool for consumption and thus enabling decision making. Thus, the method ensures that users rely on the level of certification as a trust mark that is up to date. For the sake of an analogy, when booking a restaurant, a user looks for the latest reviews as these are more reliable than a review dating five years, for example the owner of the restaurant may be different. Within this analogy, there is a strong parallel with a data consumer leveraging from the visual report to make a decision or take action. The method thus provides with the level of certification a quality sticker/trust score/mark which is up to date due to the level of certification being associated with a certification date.

The method is for data analytics. In other words, the method is for enabling the automation of analytics operations based on data contained in the one or more datasets, and on the visual report generated based on the one or more datasets. In yet other words, the method enables the use of the data for decision making (e.g., based on (a) dashboard(s), (an) insight(s). (an) AI powered insight(s), (a) visual metric(s) contained in the visual report), finding trends and solving problems.

The present disclosure relates to computing a level of certification for a visual report. However, it must be understood that the method may be deployed to a plurality of visual reports, generated based on the one or more datasets or obtained per se, e.g. via a network or from a third party. In other words, the method may apply respective pluralities of tests to several subject elements among one or more datasets and/or visual reports. The subject elements may comprise a subset of the one or more datasets and/or visual report, for example a visual report and one or more of the datasets from which the visual report is generated, or one or more datasets independently of the visual report, or alternatively the whole set of the one or more datasets and/or visual report.

The method may thus be deployed over an infrastructure managing a plurality of datasets and a plurality of visual reports, each reports being based on one or more respective ones among the plurality of datasets. The infrastructure may comprise one or more servers, each having memory space for storing one or more datasets and/or one or more visual reports or data pre-computed for displaying one or more visual reports. Each server may further comprise one or more processors for executing tests.

The infrastructure may thus store, within the memory spaces, tests to be applied to different ones among the datasets and/or the visual reports, according to any relevant combination. The infrastructure may be accessible by client computer systems over an Internet and/or Intranet network, each client computer system comprising one or more processors configured for accessing the infrastructure and/or one or more servers of the infrastructure, and sending data specifying one or more tests over the network, for example after user-graphical interaction on a display of the client computer system to specify the one or more tests.

The infrastructure may further be accessible by the same and/or further client computer systems over the Internet and/or Intranet network, said same and/or further client computer systems comprising one or more processors configured for accessing the infrastructure and/or one or more servers of the infrastructure, sending a request for displaying a visual report, and displaying the visual report over a display of the client computer system.

As will be appreciated, each visual report may further comprise during user-interaction with such a client computer system, accessing, by a user, the visual report, displaying, by the computer system, a graphical representation of the level of certification of the visual report, and displaying, by the computer system, the visual report. Optionally, the method may further comprise displaying a graphical representation of the certification date, for example simultaneously and/or aside the a graphical representation (e.g. textual representation) of the level of certification of the visual report. Thanks to the displaying of the graphical representation of the level of certification of the visual report and optionally of the graphical representation of the certification date, the user may make informed decisions, and for example, interact with the datasets and/or the visual report based on the level of certification displayed. For example, the user may launch an industrial or commercial process based on the visual report, when the report is certified or has a high level of certification. In another example, the method may enable that the user not to share the visual report to other third parties when the report is not certified or de-certified or has a low/poor or negative level of certification. For example, the user or another (e.g., contacted) user may interact with one or more servers, via the client computer system or another computer system, to rework and/or complete and/or edit data within the one or more datasets and/or within the visual report, so as to achieve certification and/or improve the level of certification after re-applying the tests as long as the tests provide a positive level of certification.

By “dynamically” it is meant that steps of the method are repeated at different times, for example at regular intervals of time (alternatively irregular intervals of time), or that at least some steps of the method are performed (e.g., at least once) upon the detection of an event, e.g., as time changes and/or as circumstances evolve, for example according to the evolution of the data or to the evolution of the visual report. For example, the steps of the method may be performed repeatedly, upon detecting that the visual report is modified or upon a predetermined time period elapses.

By “automatically” it is meant that steps of the method are performed without user-intervention. In particular, once the tests are defined/set/specified (e.g., optionally by a user), execution of the tests is fully automatic. Execution of steps of the method performed automatically may be planned according to a schedule or to a predetermined list of tests, e.g., in an order of priority.

The one or more datasets may be obtained at S10, e.g., through a network directly or indirectly from sources such as data warehouses, data marts, and/or data lakes. Additionally or alternatively, the one or more datasets may be obtained from third parties, e.g., via BI frameworks such as Tableau. Power BI. SAP BusinessObjects. Qlik. Looker. ThoughtSpot. Cognos or the like. Additionally or alternatively, the one or more datasets may be obtained from other data sources stemming from technologies such as Oracle. Snowflake or SQL server. The data sources may be of any format, for example, an Excel file format or GSheet or the like. It is to be understood that the one or more datasets may be obtained from an unlimited type of data sources and the above examples are provided for the sake of illustration.

The method may generate a visual report based on only one dataset or a plurality of datasets. The method may use the one or more datasets for different visual reports. In other words, the one or more datasets may be shared between different visual reports.

Each visual report is generated based on the one or more datasets.

By “visual report” it is meant any kind of data arrangement enabling a visual representation (e.g., comprising a graphical representation of text, rendered 2D and/or 3D elements or the like) of data contained in or derived/derivable from the one or more datasets. Obtaining the visual report may comprise applying any kind of computation (e.g., data filtering over one or more criteria such as a period of time) or data conversion to the one or more datasets. The visual report may thus comprise data under a desired type of representation (for example displaying KPIs, charts, gauges) and navigation elements (filters, buttons, and/or the like) configured to allow user-interaction with the data represented by the visual report, e.g., a country or region filter, date filter or the like. The visual report may comprise any combination of insights. AI powered insights, visual metrics and dashboards.

The method applies at S20 a plurality of tests each to a subject element among the one or more datasets and/or the visual report. The tests may be based on a plurality of business rules and/or technical rules. The technical rules may be based on user-experience rules, performance rules, the accuracy of the data represented by the subject element or the like. The application S20 may be (e.g., at least partially) user-defined, for example defined according to the needs of the user (e.g., when the visual report starts providing results or at any given time) such as a performance goal. The application S20 may also evolve dynamically over time. For example, users may change/update tests as needed.

The method computes S30 a level of certification for the visual report. The level of certification for the visual report is based on a number of tests providing a positive result.

The computing may be performed in any manner. For example, the computing S30 may comprise determining the number of tests providing a positive result. Alternatively and/or additionally, the computing S30 may comprise determining the number of tests providing a negative result. The computing S30 may comprise comparing the number of tests providing a positive result and/or the number of tests providing a negative result to a respective threshold. The respective threshold may or may not depend on the total number of tests and/or on the nature of the tests and/or on the visual report (or other element) being certified or de-certified.

The level of certification is metadata (e.g., comprising information on the visual report such as the name of the file, permission information, visual information on the certification of the visual report or other type of information such as text) measuring an extent by which the number of tests provides a positive result. In other words, the method computes metadata representing the satisfaction of the applied plurality of tests. The metadata may be stored on persistent (i.e., non-volatile) memory such that it can be retrieved at any time, e.g., immediately after it has been created. Computing the level of certification for the visual report may comprises obtaining a certification date. The method may add the certification date (that is, the date at which the level of certification is computed) to the metadata. The metadata may be changed dynamically upon later executions of the method, e.g., after a predetermined time upon the detection of an event. In other words the level of certification is changed dynamically by the method as circumstances on the data represented by the visual report evolve. The metadata may update the certification date each time at which the level of certification is computed.

The level of certification can take values within any predetermined set. For example, the level of certification can take values within a discrete or finite set of levels of certification, for example labels or discrete range of numerical values. Alternatively, the predetermined set can be a continuous (non discrete or infinite) set of value, for example a range of numerical values. In case the levels of certification are among a range of numerical values, for example integers or real numbers, the range may consist of positive numbers. 0) (zero) and positive number, or both positive and negative numbers (and optionally 0)-zero), or any other combination.

The level of certification may be “certified” (that is, a large number of tests provides a positive result, thereby showing that the visual report is certified, and/or reliable, and/or endorsed and/or valid and/or trustworthy) or “de-certified” (that is, a predetermined number of tests may provide a relatively low number of positive results). Optionally, the level of certification may be comprised between intermediate levels of certification. The intermediate levels of certification may be ordered, for example a gold level of certification may represent the highest level of certification, a silver level of certification may represent an intermediate level of certification, and a bronze level of certification may represent the lowest level of certification by which the visual report is deemed to be certified. The intermediate level of certification may also be associated to the certification date. For example, a test run January 1st on a visual report A (being certified) may be is a metadata created attached to report A indicating: test ok, certification is on (could be level bronze of certification or silver . . . ), with a date of certification is January 1st. The metadata may have an expiration date of certification of seven days. In other words, the visual report is certified until January 8th. If no new certification is done January 9th, the method may display the message “Expired bronze certified”. The level of certification may depend on the number and nature of tests that provide a positive result. The method may thus follow an “all or nothing” strategy, or alternatively, a finer strategy.

The method may apply the number of tests in any manner. For example, the method may apply a predetermined number of tests systematically and mandatorily (i.e., at least once during execution of the method). Additionally or alternatively, the method may also apply a predetermined number of tests according to a hierarchy of the application of a test. For example, a first test yielding a positive result may trigger the application of a second test. If the first test yields a negative result, the result may trigger the application of a third test. Optionally, the method may apply a number of tests depending on predetermined circumstances, e.g., upon failure of a mandatory test or upon the selection by a user.

The level of certification may be computed at any time, and/or upon a change of events or conditions. For example, the method may measure the time to load the visual report (e.g., when loading a large quantity of data) and/or evaluate the behavior of the visual report upon a variety of conditions (e.g., when being accessed simultaneously by a large quantity of users). The method may apply a respective number of tests based on the measured time and or the result of the evaluation. The tests may also be refined to specific actions on the visual report, for example when clicking buttons and/or changing filters displayed with the visual report.

In examples, the level of certification may be based on computing an Application Performance Index (APDEX). The APDEX may measure the satisfaction of the user when interacting with the visual report (for example when displayed on a Web application). The APDEX may vary between 0 and 1, where I indicates that the user is satisfied, while ( ) indicates that the user is dissatisfied. The APDEX may be compared to a predetermined threshold to determine the level of satisfaction of the user. The method may determine that the visual report is certified if the APDEX is above the predetermined threshold. The method determines that the visual report is de-certified otherwise. The method may determine the level of certification according to predetermined ranges of values between 0 and 1. Additionally or alternatively, the method may determine that the level of satisfaction is “tolerable” (that is, an intermediate level of certification) when the APDEX has a value within intermediate values of ranges.

The method may further comprise, during user-interaction with a computer system accessing, by a user, the visual report. In examples, the computer system may be a personal computer, a portable device such as a tablet or smartphone or a virtual reality device. The user-interaction for accessing the visual report may include for example, clicks using a mouse, keyboard actions, or touchscreen interactions such as finger pression interactions, for example while pressing a graphical representation of the visual report, e.g., through a display of an icon of the visual report.

The method thus improves data analytics. The method automatically and dynamically validates the data represented in the visual report for the user so that the user is presented with accurate and reliable data. Indeed, thanks to the method computing the level of certification, user experience with the visual report is improved, as the user is provided with accurate data. Indeed, as the level of certification is based on the number of tests providing a positive result, the level of certification is an accurate and objective indicator of the reliability of the data represented in the visual report (and similarly, the obtained one or more datasets).

The accuracy and reliability are achieved thanks to the plurality of tests allowing a complete assessment of the accuracy of the subject element among the one or more datasets and/or the visual report. Indeed, the plurality of tests may cover pre-established scenarios that may anticipate known problems on the accuracy of the data. Moreover, the plurality of tests may also comprise exploratory tests. The exploratory tests add a dimension to the testing procedure, as the exploratory tests discover problems that have not yet been anticipated, for example when navigating or interacting with the visual report.

In addition, thanks to steps of the method being performed dynamically and automatically, the method maintains the operational performance of the visual report during use, for example during data analytics or business intelligence processes. Indeed, the automation allows to apply the plurality of tests with regularity (for example when the tests are applied (i.e., run or execute) at predetermined time intervals) and/or as the visual report evolves (for example when the application of the tests is triggered by a particular event).

The method may be part of an analytic process. For example, the method may be incorporated in visual reports generated by solutions such as Tableau. Tableau may generate automatically a visual report or a trend (also called “pulse”) based on a given dataset. The method may enable to impede the generation of the visual report (that is to say, enable to block the pulse) on the level of certification, for example when the dataset is de-certified. In another example, RPA may open a visual report, interact with the visual report, and based on a given KPI, create an ordering or any relevant business process. The method may enable pausing RPA if the visual report is de-certified.

The method may also further comprise displaying, by the computer system, a graphical representation of the level of certification of the visual report. This enables understanding of the level of certification by a user who wants to interact with the visual report.

The method may also further comprise displaying, by the computer system, the visual report. The method may display the visual report and the graphical representation of the level of certification of the visual report concomitantly (e.g., one next to the other in a display of the computer system). In examples, the method may comprise displaying the visual report, and display the level of certification when the user interacts with the visual report, e.g., as a pop-up or textbox message, as described below.

Optionally, the method may also comprise displaying a graphical representation of the one or more datasets obtained at S10. The method may for example display icons corresponding to the one or more datasets. The method may also display associated metadata and/or a respective level of certification of the one or more datasets.

The graphical representation of the level of certification of the visual report may be displayed simultaneously (for example at a predetermined position of the screen) to and/or before the displaying of the visual report, for example upon user action when accessing the visual report. In examples, the graphical representation may be displayed (e.g., simultaneously) on another system for example on a tablet on or a portable device such as a smartphone, or as a notification on a virtual reality device. The user is thus provided with a graphical indicator on whether the visual report is reliable, and/or endorsed and/or valid and/or trustworthy.

The graphical representation of the level of certification of the visual report may be one of a badge, an icon, a stamp, a sticker, a watermark, a text box message or a trust mark. For example, the badge (similarly icon, stamp, sticker, watermark, text box) message may be displayed (e.g., simultaneously with the visual report) at a predetermined position of the visual report (e.g., displayed on a top corner or a bottom corner). The graphical representation (one of the badge, the icon, the stamp, the sticker, the watermark, the text box message as mentioned above) may display text indicative of the level of certification. The text may for example read “certified” when the number of tests providing a positive result leads to the visual report being certified, and “de-certified” when the number of tests providing a positive result lead to the visual report being de-certified. It is to be understood that the use of the words “certified” or “de-certified” may be presented to the user in any preferred language, such as English. French. Spanish. German or any other language. It is also to be understood that the text indicating that the visual report is certified may be different according to the business word which is most relevant, for example, if the visual report is certified, the text may comprise the words “validated”. “trusted”. “endorsed”. “reconciled” or any other similar text depending of the business context. Similarly, if the visual report is decertified, the text may comprise the words “unvalidated”. “not endorsed”. “not reconciled” or any other similar text depending of the business context. The graphical representation (one of the badge, the icon, the stamp, the sticker, the watermark, the text box message as mentioned above) may also display a certification date indicating the date of application of the computation of the level of certification. The method may for example display the phrase “expired” when determining that the certification date is too far from the date in which the visual report is consulted.

The graphical representation of the level of certification of the visual report may also be a notification stemming from a custom extension such as an API (for example an extension as found in SAP BusinessObjects. Tableau or Power BI). The graphical representation of the level of certification of the visual report may also be a notification stemming from a native certification flagging feature, e.g., Tableau for Data Sources (in the case of the certification or de-certification of at least one dataset) or Power BI (for a subject element among the dataset or the visual report). The graphical representation of the level of certification of the visual report may also be a notification stemming from a process such as email, such as Outlook or the like, for example the email may comprise text indicating the level of certification of the visual report such as “certified” or “de-certified”. Other equivalent expressions may be used depending on the dataset and/or the visual report, such as “validated” “reconciled” for indicating that the visual report is certified. The graphical representation may also stem from an instant messaging application, e.g., a message appearing on a smartphone or tablet, for example the message including text indicating that the visual report is certified or de-certified, or stem from a support ticket system. The graphical representation of the level of certification of the visual report may also be a notification stemming from a Browser extension.

The plurality of tests may comprise one or more of a data quality test, a metadata test, a functional or user-interaction test, a security test, an accessibility or design test, a regression test, and a performance test. Each test of the plurality may be applied at different times, or upon different actions. For example, the functional or user-interaction test may be applied when performing a user-action on the visual report. Additionally or alternatively, a two or more tests of the plurality may be applied concomitantly (i.e., at the same time). For example, the performance test may be applied at the same time as the accessibility or design test. Additionally or alternatively, two or more tests of the plurality may be applied in a sequence. For example, the functional or user-interaction test may be applied when performing a user action on the visual report (e.g., when accessing the visual report), and the method may apply the performance test after the application of the functional or user interaction test.

Thus, the method improves the reliability of the visual report. This is thanks to the level of certification indicating a degree of trust and credibility one can have in the data represented in the visual report and/or in the one or more datasets. This is allowed by the method applying the plurality of tests to the subject element among the one or more datasets and/or the visual report. The plurality of tests allows to find issues in said subject element that may go undetected by a manual verification.

Hence, decision makers may be presented with an objective indicator of the reliability of the data, and are thus able to make informed decisions based on the visual report. For example, decision makers are enabled to leverage from the insights of the visual report, in case the level of certification represents a positive or high reliability of the data represented in the visual report. This may be subject to the visual report being thereby “certified”, e.g., based on a number of tests providing the positive result being higher or equal than a threshold, for example a relatively high number of tests providing a positive result. On the contrary, in case the level of certification represents a negative or low/poor reliability of the data represented in the visual report, the user may be prompted to perform a corrective action (e.g., obtain updated data) for improving the reliability of the visual report. The visual report may for example be “de-certified” or “non-certified”, e.g., based on a number of tests being lower than a threshold, for example a relatively low number of tests providing a positive result. The visual report may further be rendered inaccessible to the user while the visual report is de-certified.

The automatic execution of the plurality of tests thus allows to avoid errors due to a human bias, while reinforcing the credibility of the visual report in a trustworthy and efficient environment. Indeed, if the level of certification leads to a de-certified result, e.g., due to a low number of tests providing a positive result, the method may further show a graphical representation of the level of certification to the user (e.g., in the form of a sticker, watermark or other type of visual information).

Additionally or alternatively, if the level of certification leads to a de-certified result, the method may rename the visual report (e.g., the visual report being now renamed as being de-certified or obsolete, and/or the name of the visual report being displayed to the user, thus forming a graphical representation of the level of certification as such). The method may also change security settings of the visual report so as to restrict user-access to the visual report after the report is deemed uncertified, thus rendering the visual report inaccessible or and/moving the report to an inaccessible location in the system. The method may perform foregoing steps while the visual report is deemed de-certified. The method may continue to apply the plurality of tests and restore the visual report as being certified (the visual report being thus deemed to be “re-certified”) when determining that the plurality of test yielding a positive result are high enough, for example, when a corrective action has been performed on the dataset or the visual report.

In addition, the method may optionally enable ensuring that the visual report remains certified at each evolution or modification thereof, for example during continuous collaboration by different parties, such as developers, business analysts or other end users. This is because the method performs the steps dynamically and automatically, and thus the method continuously adapts the computed level of certification of the visual report. In turn, users may be enabled to perform all necessary corrective actions, so as to maintain the performance and precision thereof under evolving and changing conditions that may hamper the performance or reliability of the data presented by the visual report. The method thus allows end users to automate the decision-making process in analytic operations.

The method is computer-implemented. This means that steps (or substantially all the steps) of the method are executed by at least one computer, or any system alike. Thus, steps of the method are performed by the computer, possibly fully automatically, or, semi-automatically. In examples, the triggering of at least some of the steps of the method may be performed through user-computer interaction. The level of user-computer interaction required may depend on the level of automatism foreseen and put in balance with the need to implement user's wishes. In examples, this level may be user-defined and/or pre-defined.

A typical example of computer-implementation of a method is to perform the method with a system adapted for this purpose. The system may be for example a personal computer, a handheld device such as a tablet or a cell-phone, or a Virtual Reality (VR) system. The system may comprise a screen, for example a touchscreen. The system may comprise a processor coupled to a memory and a graphical user interface (GUI). The GUI may allow any kind of user interaction, for example, keyboard inputs, mouse-click inputs (such as drag—and drop), touch functions (such as pinch and zoom, or any other kind of touch input) or virtual reality inputs (e.g., enabled through any kind of haptic input). The memory has recorded thereon a computer program comprising instructions for performing the method. The memory may also store a database. The memory is any hardware adapted for such storage, possibly comprising several physical distinct parts (e.g. one for the program, and possibly one for the database). The system may comprise a network adapter configured to manage access to a network. For example, the system may obtain the one or more datasets via the network.

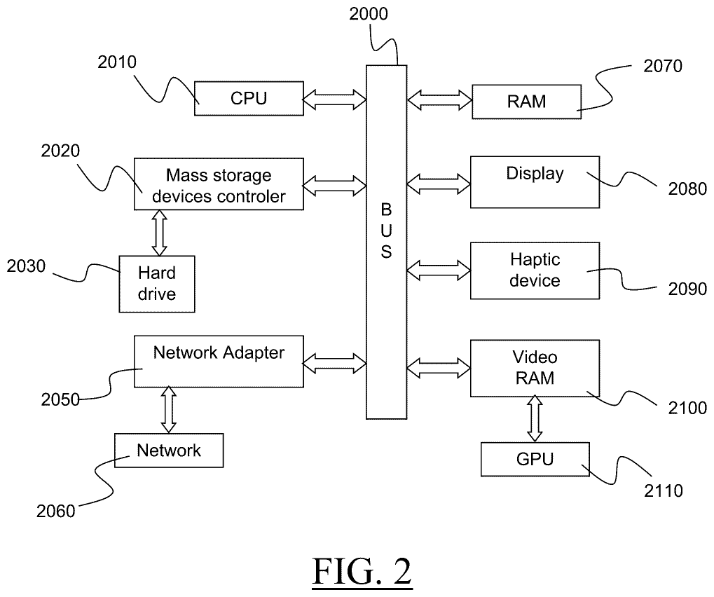

FIG. 2 shows an example of the system, wherein the system is a client computer system, e.g, a workstation of a user.

The client computer of the example comprises a central processing unit (CPU) 2010 connected to an internal communication BUS 2000, a random access memory (RAM) 2070 also connected to the BUS. The client computer is further provided with a graphical processing unit (GPU) 2110 which is associated with a video random access memory 2100 connected to the BUS. Video RAM 2100 is also known in the art as frame buffer. A mass storage device controller 2020 manages accesses to a mass memory device, such as hard drive 2030. Mass memory devices suitable for tangibly embodying computer program instructions and data include all forms of nonvolatile memory, including by way of example semiconductor memory devices, such as EPROM. EEPROM, and flash memory devices: magnetic disks such as internal hard disks and removable disks: magneto-optical disks. Any of the foregoing may be supplemented by, or incorporated in, specially designed ASICs (application-specific integrated circuits). A network adapter 2050 manages accesses to a network 2060. The client computer may also include a haptic device 2090 such as cursor control device, a keyboard or the like. A cursor control device is used in the client computer to permit the user to selectively position a cursor at any desired location on display 2080. In addition, the cursor control device allows the user to select various commands, and input control signals. The cursor control device includes a number of signal generation devices for input control signals to system. Typically, a cursor control device may be a mouse, the button of the mouse being used to generate the signals. Alternatively or additionally, the client computer system may comprise a sensitive pad, and/or a sensitive screen.

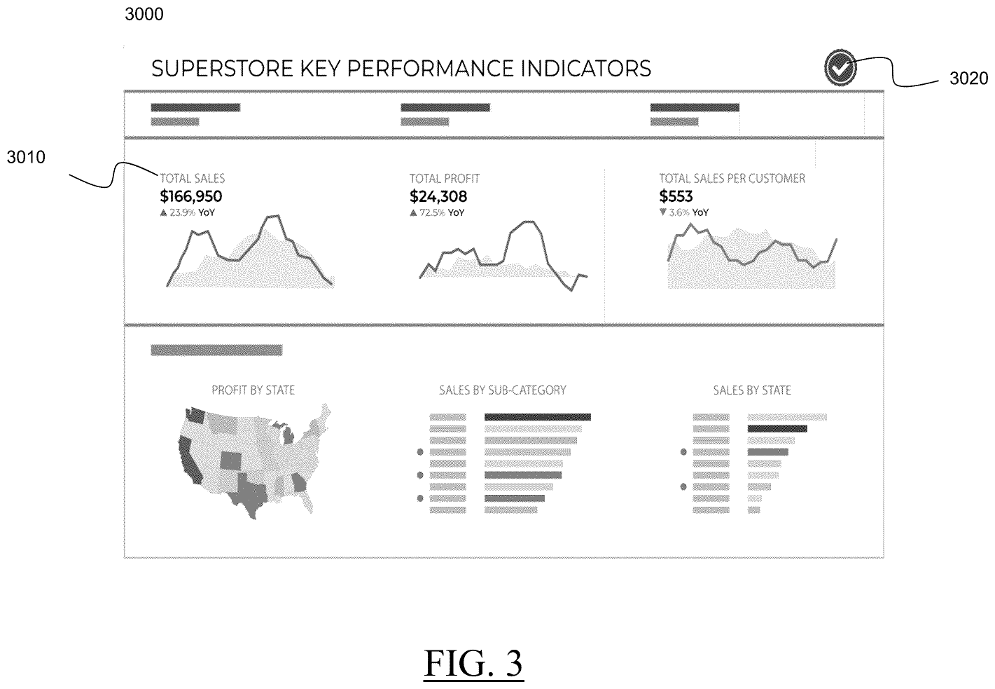

Reference is made to FIGS. 3 to 12, illustrating examples of the graphical representation of the level of certification of the visual report.

FIG. 3 shows an example of the visual report 3000. The visual report 3000 shows data 3010 generated from one or more datasets. The visual report 3000 is associated with a badge 3020 corresponding to the level of certification of the visual report. The badge 3020 shows a mark sign, thereby indicating that the visual report is certified (based on a computed level of certification for the visual report based on a number of tests providing a positive result). Alternatively, the badge 3020 may show a cross sign indicating that the visual report is de-certified (not shown).

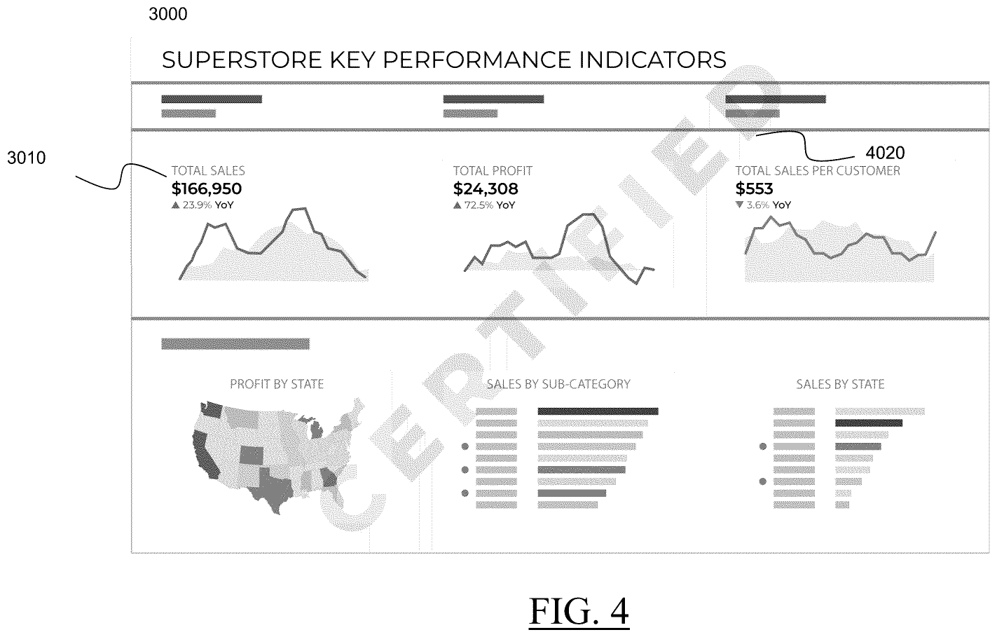

FIG. 4 shows another example of the visual report 3000. The visual report 3000 is associated with a watermark 4020. The watermark shows the characters “CERTIFIED”, thereby indicating that the visual report is certified. Alternatively, the watermark 4020 may show the characters “DE-CERTIFIED” indicating that the visual report is de-certified (not shown). The watermark may be indicated in any language. The language of the watermark may be set in advance.

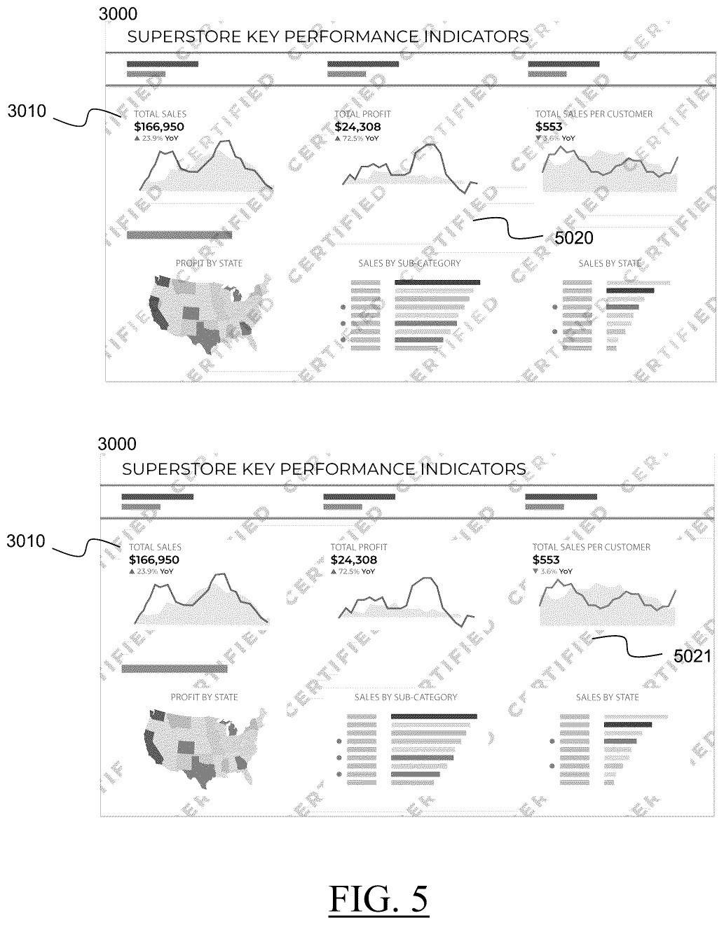

FIG. 5 shows another alternative of the watermark. In this case, the watermark 5020 may repeat the characters in a transparent font, placed in front of the content displayed by the visual report.

FIG. 5 shows another alternative of the watermark. In this case, the watermark 5021 may repeat the characters in a transparent font, placed behind the content displayed by the visual report, so as to allow to completely view the content.

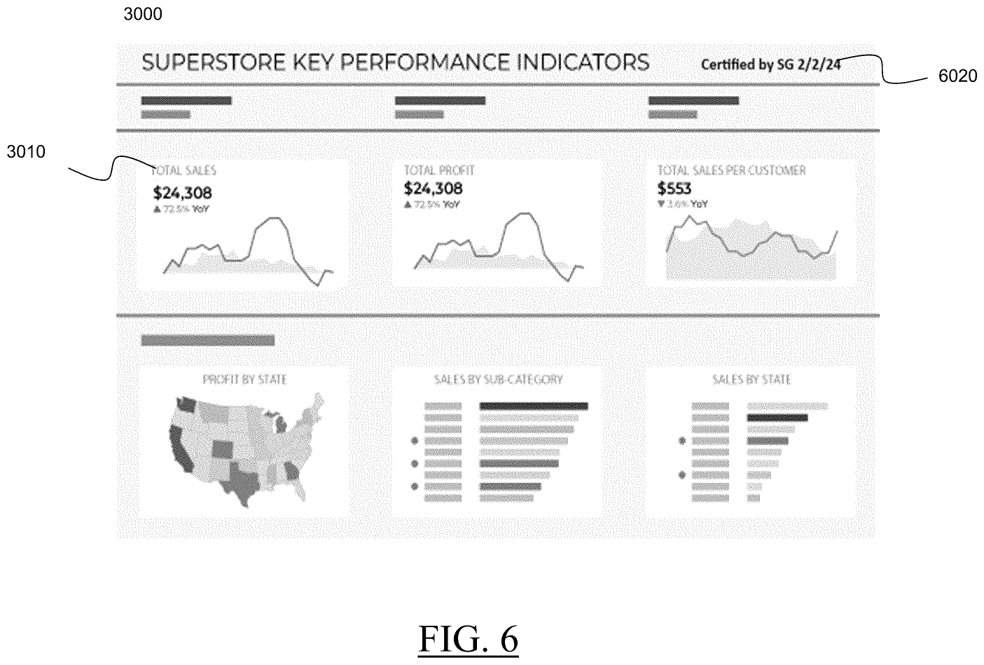

FIG. 6 shows another example of the visual report 3000. The visual report 3000 is associated with a stamp 6020. The watermark shows the characters “Certified by SG Feb. 4, 2024”, thereby indicating that the visual report is certified with the identity of the user on behalf who ran the automatic and dynamic test. The user may be a user of a BI/analytics solution that validates row level security. This allows to track the last certification date.

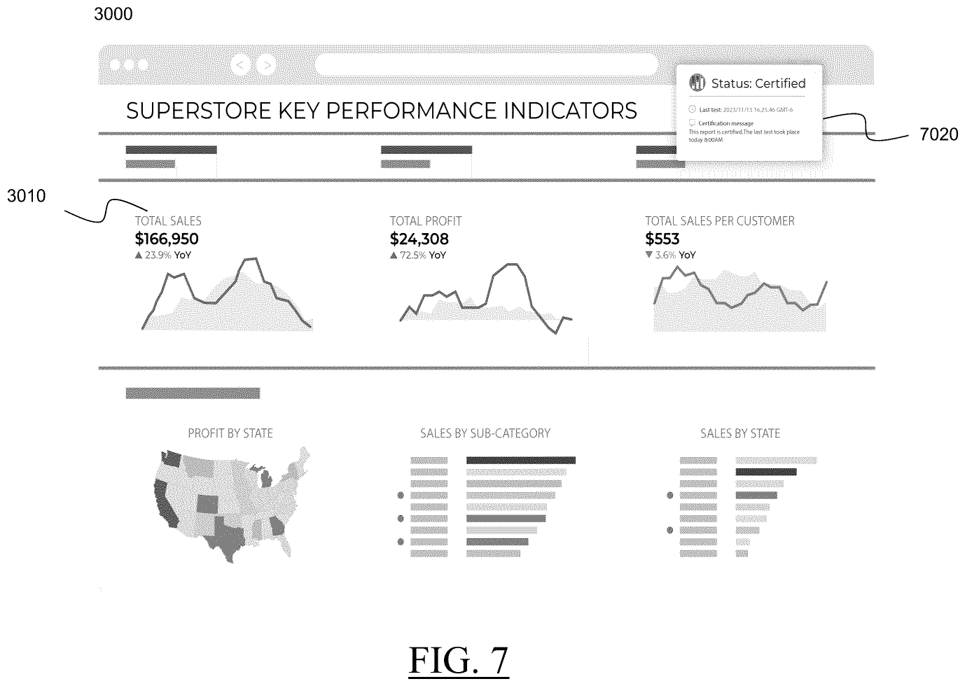

FIG. 7 shows another example of the visual report 3000. The visual report 3000 is associated with a textbox message 7020. The textbox message shows the characters “Status: Certified”, together with an indication of the last date of the application of a test, and a certification message. Alternatively, the textbox message 7020 may show the characters “Status: De-certified”, thereby indicating that the visual report is de-certified (not shown).

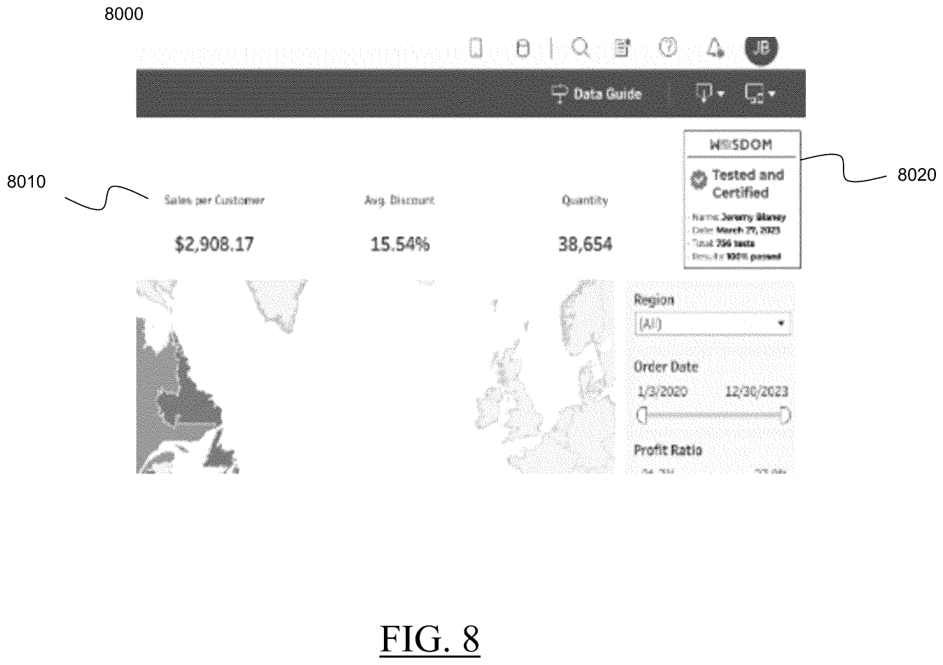

FIG. 8 shows another example of the visual report 8000. The visual report 8000 shows sales data 8010. The visual report 8000 is associated with an extension 8020. The extension 8020 shows the characters “Tested and Certified”, together with text indicating the identity of a person running the test (that is, the user who validated the test applied dynamically and automatically), text indicating the last date of the application of a test, text indicating the number of tests applied, and text indicating the number of tests yielding a positive result. In this case, one hundred percent of the tests applied with the method as described above yield a positive result, thereby indicating that the visual report is certified. Alternatively, the extension 8020 may show the characters “De-certified”, thereby showing that the visual report is de-certified.

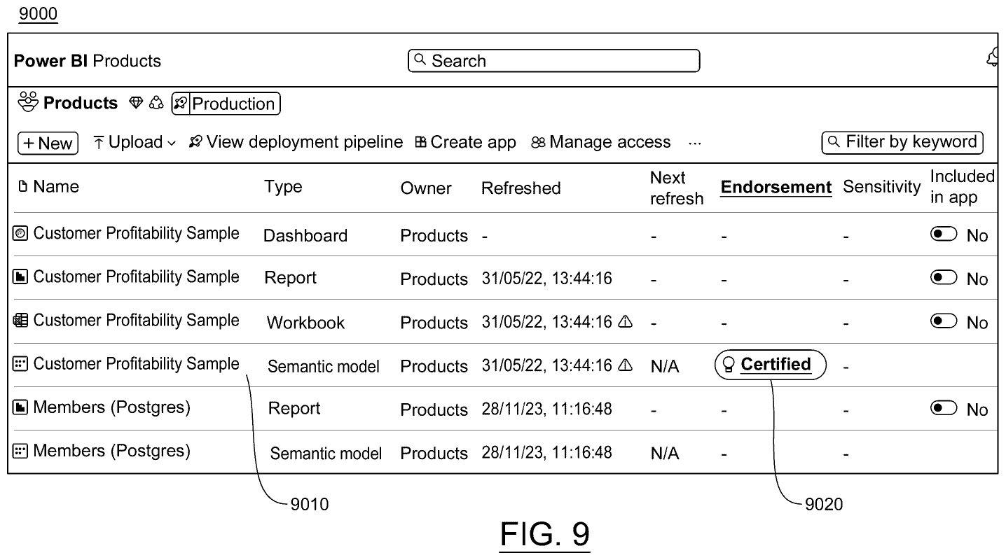

FIG. 9 shows an example of the certification shown natively in a dashboard 9000 of the business intelligence software package Power BI. The dashboard 9000 shows a dataset 9010 and an endorsement (i.e., certification) message. The endorsement message shows the icon “certified” thereby indicating that the visual report is certified. Alternatively, the endorsement may show the characters “De-certified”, thereby showing that the visual report is de-certified.

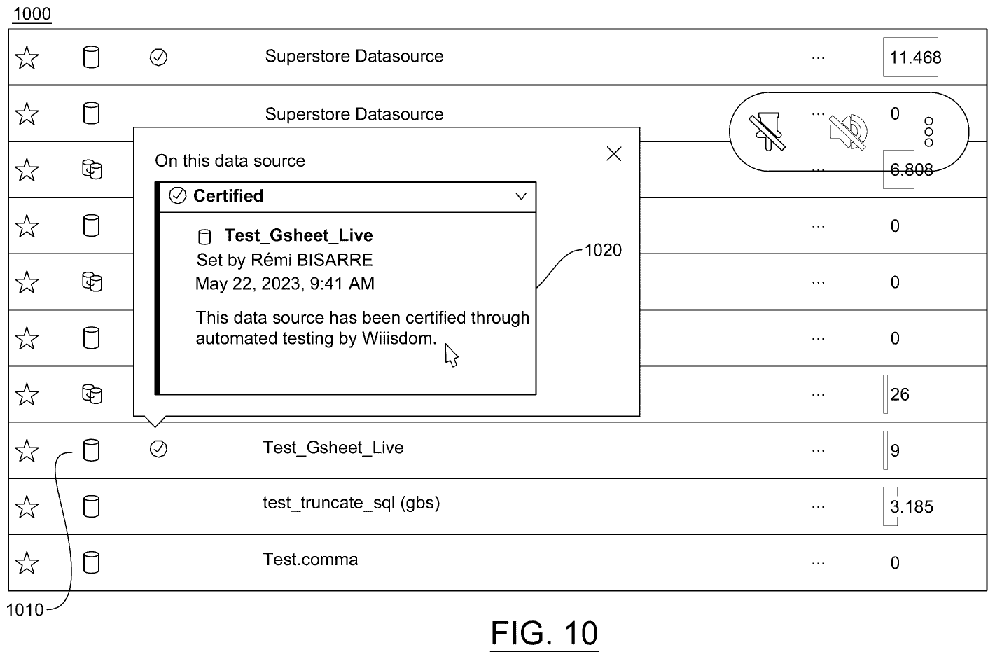

FIG. 10 shows an example of the certification shown natively in a data source 1000 of the software package Tableau. The dashboard 1000 shows a data source 1010 and a certification textbox 1020. The certification textbox 1020 shows the message “certified”. The certification textbox 1020 thereby indicates that the data source is certified (equivalently, reliable, and/or endorsed and/or valid and/or trustworthy) as the result of the steps performed by the method. Alternatively, the certification textbox 1020 may show the characters “de-certified”, thereby showing that the data source is de-certified.

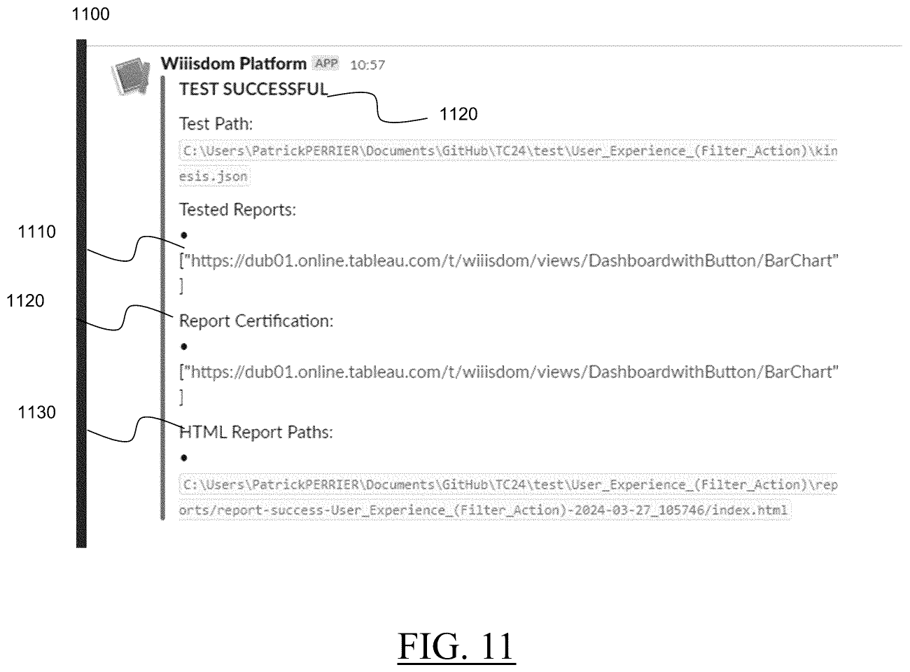

FIG. 11 shows an example of the certification shown as an instant message 1100 in the software Slack. The instant message 1100 shows information on the tested visual reports 1110, accompanied for example of the report certification 1120 and a path to find the visual reports such as an HTML report path 1130. The instant message 1100 also shows text 1120 indicating that the tests are successful 1120. The text 1120 thereby indicates that the visual report is certified. Alternatively, the text 1120 may indicate the result is de-certified (not shown).

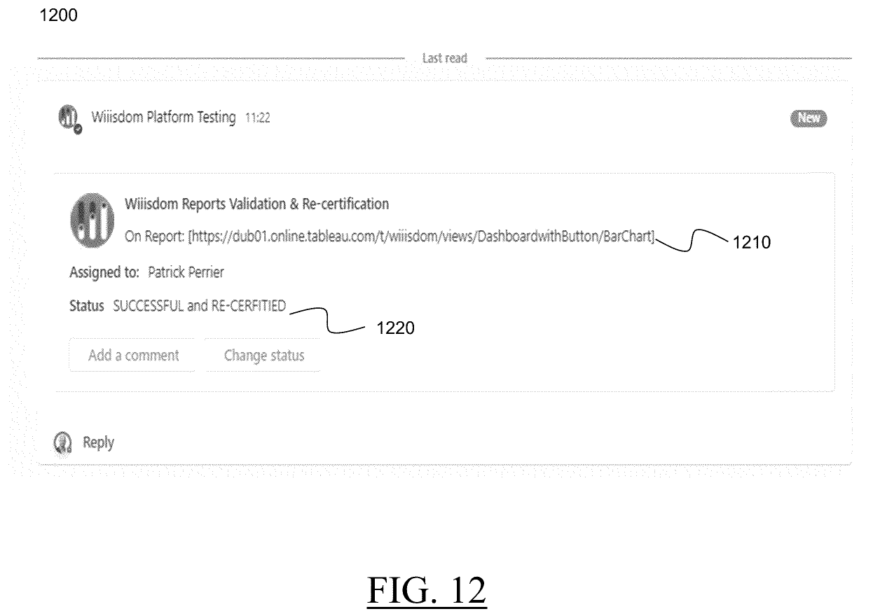

FIG. 12 shows an example of the certification shown as an instant message 1200 in the software Teams. The instant message 1200 shows text 1210 indicating the visual report and text 1220 indicating that the visual report is certified. The text 1220 shows the message “certified”. The text 1220 thereby indicates that the visual report is certified. Alternatively, the text 1220 may indicate the result is de-certified (not shown).

The data quality test may verify the integrity of the data visualized in the visual report and/or the dataset. In other words, the data quality test verifies that the data satisfies a business rule (e.g., such as having a margin between 5% and 7%) or to predetermined values. The predetermined values may be stored on a source system such as a CRM or an ERP. The method may also compare the data visualized in the visual report with data stored in the one or more datasets (from which the visual report is generated) so as to determine that the visualized data is correct. The method may de-certify the visual report if the data quality test returns a negative result, e.g., the data does not satisfy the business rule or the predetermined values, or the compared data does not correspond the data stored in the one or more datasets from which the visual report is generated.

The metadata test may evaluate components of the visual report. The method may validate the integrity of datasets and visual reports by implementing a metadata-based testing approach. The metadata under scrutiny may include, but is not limited to, elements such as data types, filters, parameters, variables, formulas, calculations, sheets, graphs, blocks, tiles, tabs, and buttons. The method thereby identifies and addresses any discrepancies or inconsistencies not only within the visual representation of the report but also in its analytical data source. This ensures that the metadata accurately mirrors the underlying analytics data, thereby upholding the fidelity and reliability of the visual report's data representation.

For example, the metadata may comprise information on components of the visual report such as datasets, filters, variables, formulas, sheets, graphs, blocs, tiles, tabs, buttons, or other information on components of the visual report such as number of sheets/tabs (and respective names), names of formulas and formulas. In other words, the metadata is a technical envelope of the visual report. The metadata test thus allows to identify inconsistencies in the metadata of the visual report.

The functional test or user-interaction test may evaluate the opening of the visual report, filters, parameters, drill-downs, buttons or any other user (human) based interactivity in the visual report. The functional test or user-interaction test may also evaluate user-interactions with the visual report, for example, when detecting a zoom (e.g., performed via a pinch and zoom gesture when the visual report is visualized on a tablet), when detecting the selection of an element displayed on the visual report (such as a graph). For example, the visual report may comprise data on countries. The visual report may have a filter “country”. The filter may be set by the user. For example, the filter “country” may be set to filter data pertaining to European countries from other countries.

The security test may evaluate that the visual report is accessed only by authorized users. The security test may also verify the integrity of the data presented to the authorized users. For example, the security test may comprise Row Level Security tests. For example, given a user A and a user B, the user A may only be authorized to view data corresponding to USA data on the visual report, while the user B may only be authorized to view data corresponding to Europe data on the visual report. The security test reinforces the security of the visual report by ensuring that user A is restricted to viewing the USA data on the visual report (at all times while consulting the visual report during decision making process) while the user B is restricted to viewing European data. This allows to reutilize the data in the visual report instead of having to create new visual reports to each user.

The accessibility or design test may evaluate how the visual report may be accessed by the user. For example, accessibility or design test may evaluate that the content displayed by the visual report is presented according to standards for people with impairments, such as that the data is presented with the right font or color, a large size font for visually impaired people. The accessibility or design test may also test if a logo displayed on the visual report is displayed correctly, e.g., if the logo is displayed with a correct height ratio, width, color coding or the like.

The performance test may comprise tests to evaluate the behavior of the visual report under load/use. In other words, the performance test may evaluate the performance of the visual report in its globality, for example, the visualization performance of the visual report (as perceived by the user) taking into account the global environment in which the visual report is presented to the user. For example, the performance test may simulate a number of users accessing simultaneously the visual report. The performance test may also evaluate the performance of the visual report, e.g., when opening the visual report, when navigating through the visual report, when clicking on buttons displayed next to the visual report. The performance test may be applied at different times. This ensures that the performance of the visual report is maintained as time passes.

The method may further comprise applying a performance test to at least one of a displaying, loading and/or interaction of the visual report. The method may also further comprise computing a performance score based on a result of the performance test. The method may also further comprise updating the level of certification of the visual report based on the result of the performance test. For example, the method may set the level of certification as “certified” if the method computes a performance score above a predetermined threshold (e.g., above zero), or “uncertified” if the method computes a performance score below the predetermined threshold. Thus, the method provides an objective indicator that the visual report performs consistently in operation. The method may apply the performance test dynamically e.g., while the visual report is being accessed in the context of Business Intelligence or Analytics. For example, if the visual report is under a high demand that hinders its performance, the method may de-certify the visual report and certify it again when the demand allows an acceptable performance (as a result from the performance score). This avoids loss of time and resources.

The plurality of tests may comprise one or more tests each applied to a respective subject element among the one or more datasets and/or the visual report. Additionally, the method applies each of the one or more tests to one or more results of applying a filtering to the respective subject element. By “filtering” it is meant any type of operations (e.g., arithmetic and/or logic operations such as Boolean operations) used for retrieving data from the subject element, for example via a query when the dataset is a database or when the visual report is generated based on one or more datasets, where at least one dataset is a database. In other words, the one or more tests are applied to the results output from the filtering, that is, partial data from the subject element.

The method may further comprise securing access to the visual report to authorized users and validating the integrity of data for the authorized users. The securing of access may comprise restricting access to data based on actors, security roles and/or settings. The method may apply row level security techniques for securing the access to the data. The method may also test the security at the level of the datasets from which the visual report is generated. Thus, the method makes the visual report inherit the restrictions for accessing data as set in the visual report. The method may dynamically verify that the actors are correctly verified during the operation of the visual report. This enhances the security settings of the visual report.

The method may further comprise storing a record and/or a result of each application of a respective test. The record may comprise details such as the test performed, the values used, the type of test, a respective user that executed the test, the certification date, a screenshot of the visual report as displayed to the user, and data displayed. For example, the method may store metadata corresponding to the result of the application of each respective test and the level of certification computed based on the number of tests providing the positive result. This allows to document all the tests, applied solutions so as to re-certify the visual report. Thereby, to the method may keep track of recurrent problems that may de-certify the visual report and hence setting solutions to the recurrent problems so that these may be treated efficiently. As the method allows to keep all of the results of the tests in the record, it is possible to keep records for audits for years. Hence, the method enables compliance to standards such as SOX or GxP.

It is further provided a non-transitory storage medium having recorded thereon a computer program. The computer program may comprise instructions executable by a computer, the instructions comprising means for causing the above system to perform the method. The program may be recordable on any data storage medium, including the memory of the system. The program may for example be implemented in digital electronic circuitry, or in computer hardware, firmware, software, or in combinations of them. The program may be implemented as an apparatus, for example a product tangibly embodied in a machine-readable storage device for execution by a programmable processor. Method steps may be performed by a programmable processor executing a program of instructions to perform functions of the method by operating on input data and generating output. The processor may thus be programmable and coupled to receive data and instructions from, and to transmit data and instructions to, a data storage system, at least one input device, and at least one output device. The application program may be implemented in a high-level procedural or object-oriented programming language, or in assembly or machine language if desired. In any case, the language may be a compiled or interpreted language. The program may be a full installation program or an update program. Application of the program on the system results in any case in instructions for performing the method. The computer program may alternatively be stored and executed on a server of a cloud computing environment, the server being in communication across a network with one or more clients. In such a case a processing unit executes the instructions comprised by the program, thereby causing the method to be performed on the cloud computing environment.

1. A computer-method for data analytics, the method comprising:
dynamically and automatically:
obtaining one or more datasets, and a visual report generated based on the one or more datasets:
applying a plurality of tests each to a subject element among the one or more datasets and/or the visual report; and
computing a level of certification for the visual report based on a number of tests providing a positive result.

2. The method of claim 1, wherein the plurality of tests comprises one or more of:
a data quality test,
a metadata test,
a functional or user-interaction test,
a security test,
an accessibility or design test,
a regression test, and
a performance test.

3. The method of claim 1, wherein the plurality of tests comprises one or more tests each applied to a respective subject element among the one or more datasets and/or the visual report, and each to one or more results of applying a filtering to the respective subject element.

4. The method of claim 1, further comprising:
during user-interaction with a computer system:
accessing, by a user, the visual report;
displaying, by the computer system, a graphical representation of the level of certification of the visual report; and
displaying, by the computer system, the visual report.

5. The method of claim 4, wherein the graphical representation of the level of certification of the visual report is displayed simultaneously to and/or before the displaying of the visual report.

6. The method of claim 4, wherein the graphical representation of the level of certification of the visual report is one of:
a badge,
an icon,
a stamp,
a sticker,
a watermark,
a text box message:
a notification stemming from a custom extension such as an API,
a notification stemming from a native certification flagging feature,
a notification stemming from a process such as email, an instant messaging application or a support ticket system, and
a notification stemming from a Browser extension.

7. The method of claim 1, wherein the method further comprises securing access to the visual report to authorized users and validating the integrity of data for the authorized users, the securing of access comprising restricting access to data based on actors, security roles and/or settings.

8. The method of claim 1, wherein the method further comprises storing a record and/or a result of each application of a respective test.

9. The method of claim 1, further comprising:
applying a performance test to at least one of a displaying, loading and/or interaction of the visual report:
computing a performance score based on a result of the performance test; and
updating the level of certification of the visual report based on the result of the performance test.

10. The method of claim 1, wherein the method further comprises obtaining a certification date associated with the level of certification computed for the visual report.

11. A non-transitory storage medium having recorded thereon a computer program comprising instructions which, when executed on a computer, cause the computer to perform a method for data analytics, the method comprising:
dynamically and automatically:
obtaining one or more datasets, and a visual report generated based on the one or more datasets:
applying a plurality of tests each to a subject element among the one or more datasets and/or the visual report; and
computing a level of certification of the visual report based on a number of tests providing a positive result.

12. A system comprising a processor coupled to a non-volatile memory, the non-volatile memory having recorded thereon a computer program comprising instructions which, when executed on a computer, cause the computer to perform a method for data analytics, the method comprising:
dynamically and automatically:
obtaining one or more datasets, and a visual report generated based on the one or more datasets;
applying a plurality of tests each to a subject element among the one or more datasets and/or the visual report; and
computing a level of certification of the visual report based on a number of tests providing a positive result.

13. The system of claim 12, wherein the plurality of tests comprises one or more of:
an integrity test,
a metadata test,
a data test,
a user-interaction test,
a security test,
an accessibility test,
a regression test, and
a performance test.

14. The system of claim 12, wherein the system is configured to communicate with a client computer, and the method further comprises:
receiving an access request to the visual report;
serving display, on the client computer, of a graphical representation of the level of certification of the visual report; and
serving display, on the client computer, of the visual report.

15. The system of claim 14, wherein the graphical representation of the level of certification of the visual report is served to be displayed simultaneously to and/or before the displaying of the visual report.

16. The system of claim 14, wherein the graphical representation the level of certification of the visual report is one of:
a badge,
an icon,
a stamp,
a sticker,
a watermark,
a text box message,
a notification stemming from a custom extension such as an API,
a notification stemming from a native certification flagging feature,
a notification stemming from a process such as email, an instant messaging application or a support ticket system, and
a notification stemming from a Browser extension.

17. The system of claim 14, further comprising:
applying a performance test to at least one of a displaying, loading and/or interaction of the visual report;
computing a performance score based on a result of the performance test; and
updating the level of certification of the visual report based on the result of the performance test.
